(19) United States
(12) Patent Application Publication
(10) Pub. No.: US 2021/0207436 A1
(43) Pub. Date: Jul. 8, 2021

(54) Ladder Stabilization Apparatus and a Stable Ladder

(71) Applicant: Christopher TAYLOR, Spring, TX (US)

(72) Inventor: Christopher TAYLOR, Spring, TX (US)

(21) Appl. No.: 17/126,016

(22) Filed: Dec. 17, 2020

Related U.S. Application Data
(60) Provisional application No. 62/956,622, filed on Jan. 2, 2020.

(51) Int. Cl. E06C 7/42; E06C 7/06

(52) U.S. Cl. CPC E06C 7/423; E06C 7/10; E06C 7/06

(57) ABSTRACT

A ladder includes a ladder stabilization apparatus which includes implements for providing sideways support, front-back support, and a bridge to rest the ladder on a structure to be climbed, such that the ladder is stable when a user climbs the ladder facing away from the structure, and the bridge allows the user to climb out of the ladder on to the structure through the bridge. The bridge also allows the user to climb on to the ladder facing from the structure, facing away from the structure, while the ladder is stable when the user climbs down while acing away from the structure.

### CROSS-REFERENCE TO RELATED APPLICATIONS

This application claims priority to the U.S. Provisional Application No. 62/956,622, filed on Jan. 2, 2020, herein incorporated by reference in its entirety.

### FIELD

The present invention relates generally to ladders, and particularly to an apparatus for stabilizing a ladder.

### BACKGROUND

Ladders are widely used to access regions at a height, for example, roof or windows of a building, for repairs, installation, among other applications. One of the key requirements is to ensure safety of a user of the ladders, that is, the person who climbs the ladder. This is particularly true for ladders with a single longitudinal profile, one end of which rests on the ground, and the other end rests on a wall of a structure the user is climbing. In such ladders, the user climbs from a front side, facing the structure.

In many situations, the user may be carrying tools, or working on the ladder in different positions, and such situations may induce instability in the user's footing or the stability of the ladder. In many cases, when the user completely climbs out of the top of the ladder onto the structure, and needs to mount the ladder from the building in the same orientation, that is, facing the structure. This maneuver also induces instability, because the user approaches the ladder facing away from the structure, and eventually needs to turn around in order to face the structure, to climb down in the same orientation as climbing up. Such and other instabilities may cause the user and/or the ladder to fall, and associated injuries, which is highly undesirable.

Accordingly, there exists a need for a ladder stabilization apparatus and a stable ladder.

### SUMMARY

The present invention provides a ladder stabilization apparatus and a stable ladder, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a user climbing a ladder having a ladder stabilization apparatus, according to an embodiment of the invention.

FIG. 2 depicts the ladder stabilization apparatus of FIG. 1, from a different viewing angle.

FIG. 3 depicts a ladder having a ladder stabilization apparatus, according to an embodiment of the invention.

FIG. 4 depicts a bridge of the ladder of FIG. 1, according to an embodiment of the invention.

FIG. 5 depicts an extension mechanism of the ladder stabilization apparatus, according to an embodiment of the invention.

FIG. 6 depicts an end portion of a leg of the ladder stabilization apparatus, according to an embodiment of the invention.

FIG. 7 depicts a ladder having a ladder stabilization apparatus, according to an embodiment of the invention.

### DETAILED DESCRIPTION

Embodiments of the present invention relate to a ladder stabilizing apparatus, and a ladder fitted with the ladder stabilizing apparatus. The ladder stabilizing apparatus includes one or more side stabilizers and one or more front-back stabilizers attachable to a ladder, for example, via a support bracket attached to a side of the legs of the ladder. In some embodiments, the ladder stabilization apparatus includes tall back and front support extensions to provide additional support to the ladder. The ladder stabilization further includes a bridge attachable to the top of the ladder. The bridge comprises two arms, each extendable from a side of the ladder, and configured to rest on a surface of a structure for which the ladder is used for access. The ladder fitted with the ladder stabilizing apparatus allows a climber or a user to climb the ladder with the user's back facing the structure, and the user to emerge from the ladder through the bridge, upwards, and board the structure. The ladder stabilization apparatus also allows the user to board the ladder, from the structure, facing away from the structure, and climb down in the same orientation. Unlike the conventional ladders, in which the user either boards on from the structure to the ladder in an orientation facing the structure by turning around while boarding the ladder from the structure, or boards the ladder facing away from the structure, but then must turn to face the structure, the ladder with the ladder stabilization apparatus allows the user to board on and board off the structure safely, facing away from the structure and climbing down facing away from the structure.

Each of the stabilizers and the bridge arms may include extendable legs to adjust length to maintain a balance even on an uneven terrain. Each of the stabilizers and bridge arms may include a shoe at an end to provide an enhanced grip when resting on the ground or the structure, respectively. In some embodiments, for example for tall ladders, the ladder stabilization apparatus includes additional stabilization components, such as, a tall back support and a tall front support.

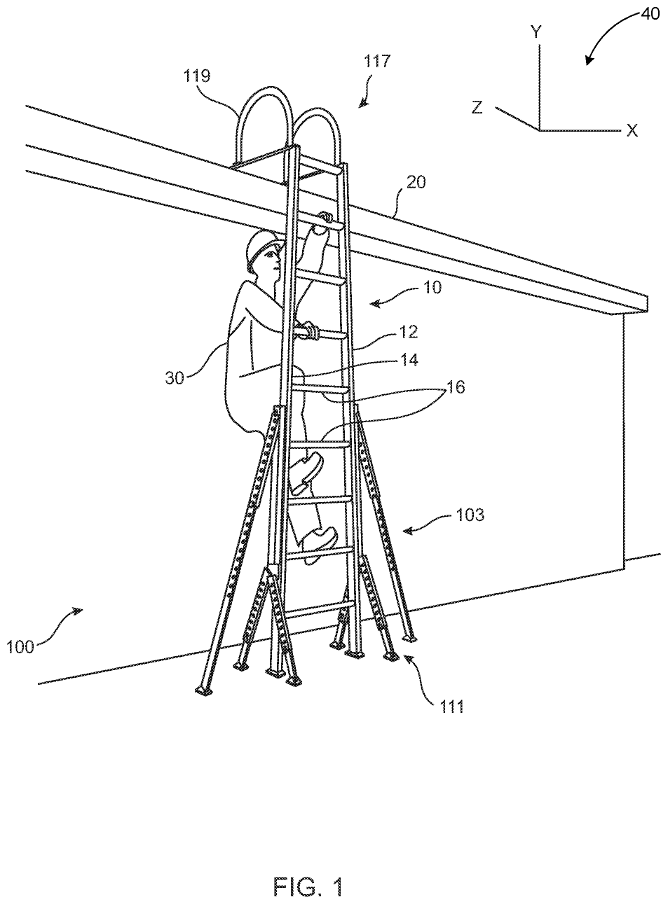

FIG. 1 depicts a user 30 climbing a ladder 10 having a ladder stabilization apparatus 100, according to embodiments of the invention. The user 30 accesses an elevated structure 20, for example a roof of a building, or any other structure to which the user 30 need to gain access to, by climbing steps 16 of the ladder 10. The ladder stabilization apparatus 100 stabilizes the ladder 10 on the ground to allow the user 30 to climb up and down the ladder 10, and climb off and on to the ladder 10 from the structure 20 safely.

For ease of reference, coordinate axes 40 (X, Y, Z) are shown, such that the X direction is the horizontal to the ground (left-right, side), that is, along the length of the steps 16, Y direction is the vertical to the ground (up-down), that is along the height of the ladder 10, Z direction is perpendicular to the X-Y plane, that is, into the building. To access the structure 20 or a part thereof, the user 30 needs to gain elevation in the Y direction. The steps of the ladder are generally horizontal, and the plane of the ladder 10 is along the X direction. Upon climbing the ladder 10, the user 30 climbs to the structure 20 by moving in the Z direction. The back of the ladder 10 is the side of the ladder 10 facing the structure 20, and the front of the ladder 10 is the side of the ladder 10 opposite the back. The front and back are on opposite sides of the ladder, along the Z direction.

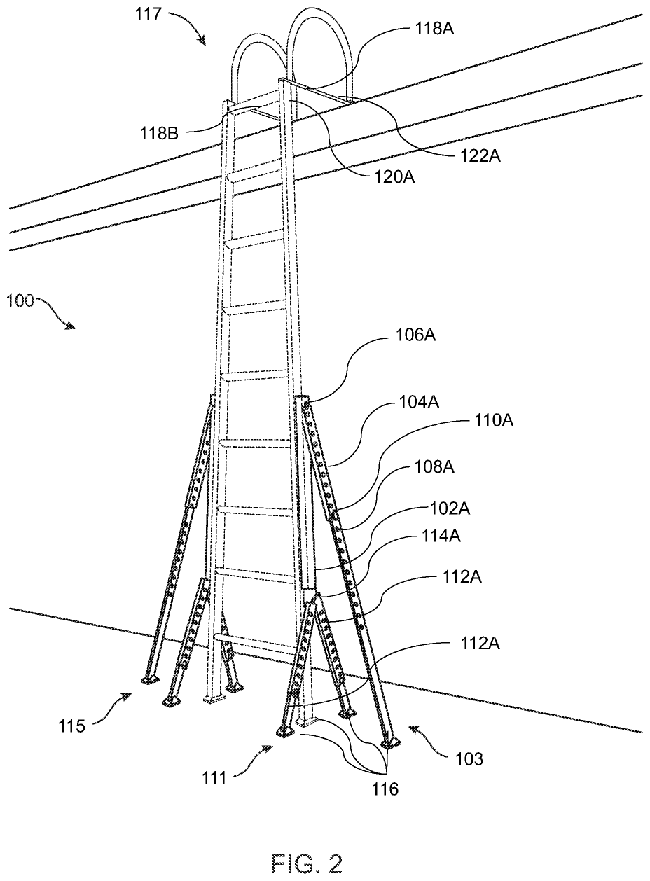

FIG. 2 depicts the ladder stabilization apparatus 100, according to embodiments of the invention. The ladder 100 comprises a first side 12 and a second side 14, each side extending longitudinally upwards (Y direction), and multiple steps 16 fixed between the first and the second sides 12, 14. The steps 16 are generally placed equidistant to each other, but may be placed at different distances. The stabilization apparatus 100 includes a first support bracket 102A attached to the first side 12, proximal to a lower end of the ladder 10. The first support bracket 102A has a top end 102A-T and a bottom end 102A-B. A first side stabilizer 103A extends from the top end 102A-T, and a first front-back stabilizer 111A extends from the bottom end 102A-B.

The first side stabilizer 103A includes a side leg 104A affixed at its top end 104A-T to the first support bracket 102A proximal to its top end 102A-T by a side leg joint 106A. A bottom end 104A-B of the side leg 104A is coupled to a top end 108A-T of a side extender leg 108A by a side extender leg joint 110A. The side leg 104A and the side extender leg 108A comprises holes 105A, 107A respectively, through which the joint 110A joins the side leg 104A and the side extender leg 108A, preventing relative movement therebetween. Overlap between the side leg 104A and the side extender leg 108A can be adjusted to align the holes 105A, 107A, achieve a desired overall length of the first side leg 104 and the first side extender leg 108, and reconfigure the joint 114A to the aligned holes to achieve a desired length of the first side stabilizer 103A. Such a relative, adjustable locking mechanism, which uses the joint 110A and holes 105A, 107A to adjust a combined length of two components, that is, the side leg 104A and the side extender leg 108A, respectively, is referred to as an “extension mechanism,” which makes stabilizer 103A extendable. Extension mechanisms are used in several components of the ladder stabilization apparatus, for example, as discussed below.

The side extender leg 108A includes a shoe 116A affixed to its bottom end 108A-B, to rest on the ground, and for enhancing grip of the side extender leg 108A on the ground, or a resting surface. The side stabilizer 103A, configured to a correct length with respect to the ground, provides stability to the ladder 10 against movement to the first side 12.

The front-back stabilizer 111A includes a pair of front-back legs, with a front leg 112A extending to the front of the ladder 10, and a back leg 112B extending to the back of the ladder. Each of the front and the back legs are affixed to the bottom end 102A-B at their respective top ends by a front-back leg pair joint 114A. The front and the back legs includes holes 113A to adjustably affix to the bottom end 102A-B by reconfiguring the joint 114A in different holes. In some embodiments, each of the front and the back legs 112A, 112B include an extension mechanism. In some embodiments, each of the front and back legs 112A, 112B includes respective shoes 116A at their bottom end, for example, to rest on the ground, and for enhancing grip of the front and back leg pair 112 A, 112 B on the ground, or a resting surface. The front-back stabilizer 111A, configured to a correct length with respect to the ground, provides stability to the ladder 10 against a front-back movement of the first side 12.

The ladder stabilization apparatus 100 further includes a second support bracket 102B affixed to the second side 14 of the ladder 10. The second support bracket 102B is a mirror image of the first support bracket 102A. The second support bracket comprises a second side stabilizer 103B and a second front-back stabilizer 111B, each of which are a mirror image of the corresponding first side stabilizer 113A and the first front-back stabilizer 111A, comprising all components as described above. All numerals for the first side 12 components include an “A,” and the corresponding numerals for the components of the second side 14 include a “B,” with the exception of front-back leg pair, in which the first side front leg is 112A, first side back leg is 112B, second side front leg is 112C, and the second side back leg is 112D. The side stabilizer 103B, configured to a correct length with respect to the ground, provides stability to the ladder 10 against movement to the second side 14. The front-back stabilizer 111B, configured to a correct length with respect to the ground, provides stability to the ladder 10 against a front-back movement of the second side 14.

The ladder stabilization apparatus 100 further includes a bridge 117 affixed proximal to a top end of the ladder 10. The bridge 117 comprises a first bridge arm 118A extending from a top portion of the first side 12, in a direction perpendicular to the plane of the ladder, that is, the Z-direction. In some embodiments, the first bridge arm 118A extends from the top of the first side 12. The first bridge arm 118A is affixed to the first side by a joint 120A at a first side of the first bridge arm 118A, opposite which, the first bridge arm 118A includes a shoe 122A for enhancing grip of the first bridge arm 118A on the structure 20, or a resting surface. In some embodiments, the first bridge arm 118A comprises an extension mechanism, and is extendable. The bridge 117 includes a second bridge arm 118B, which is a mirror image of the first bridge arm 118A. The bridge 117 stabilizes the ladder 10 with respect to the structure 10, against any movement away from the structure 20, particularly when the user 30 climbs the ladder 10 from the back of the ladder 10, that is, the side of the ladder 10 directly facing the structure 20.

In some embodiments, the bridge 117 further includes arm rails 119 extending upwards from the first and the second sides 12, 14, and extending away from the plane of the ladder 10 (Z-direction). The arm rails 119 help the user 30 in climbing off the ladder 10 onto the structure 20, and climbing on to the ladder 10 from the structure 20.

In some embodiments, the first and the second sides 12, 14 also include an extension mechanism with corresponding extender legs, configured to extend from the bottom of the first and the second sides, and adjustable to a desired length. The extendable first and second sides allow for use of the ladder 10 on uneven ground surface, or other configurations, such as the first side on the ground and the second side on a stair, above the ground. Further, each of the first and the second sides 12, 14 include a shoe 116 for enhancing the grip of the first and the second sides on the ground, or a resting surface.

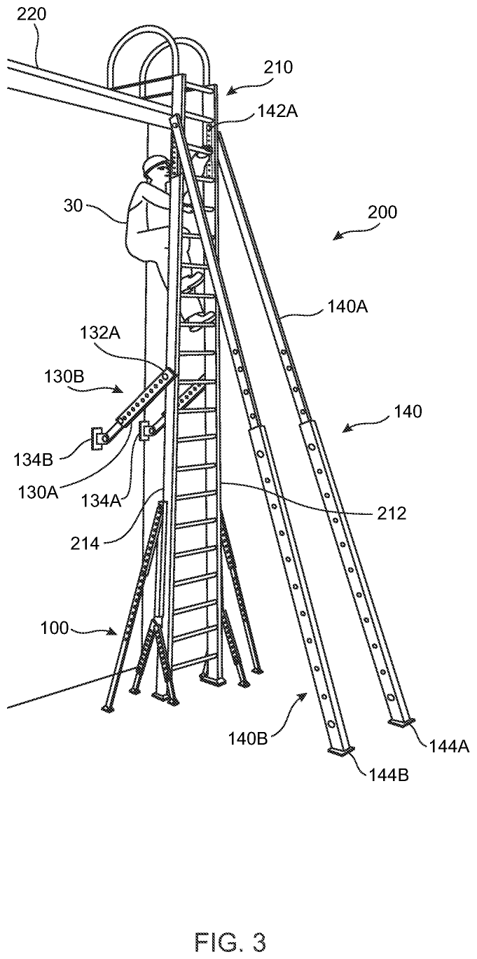

FIG. 3 depicts a ladder stabilization apparatus 200, affixed to a ladder 210, according to embodiments of the invention. The ladder 210 is similar to the ladder 10, except that the ladder 210 is taller than the ladder 10. The ladder stabilization apparatus 200 may be affixed to tall ladders, for example, the ladder 210, or any ladder in which additional stability is desired, including the ladder 10. The ladder stabilization apparatus 200 includes the ladder stabilization apparatus 100 of FIGS. 1 and 2 affixed to the ladder 210 in a manner similar to that described above, and additionally, includes a tall back support 130, optionally comprising an extension mechanism, and a tall front support 140, optionally comprising an extension mechanism, for additional front and back stability of the ladder 210.

The tall back support 130 includes a first tall back support 130A extending from a middle portion of a first side 212 of the ladder 210, and a second tall back support 130B extending from a middle portion of a second side 214 of the ladder 210. The first tall back support 130A comprises an extension mechanism, for example, similar to the side leg 104 and the side extender leg 108. The first tall back support 130A is affixed to the ladder 210 at its first end by a back support joint 132A, and at its second end opposite the first end, includes a back support shoe 134A to rest on, and enhance grip with a wall or a portion of a structure 220, or a resting surface. The second tall back support 130B is a mirror image of the first tall back support 130A.

The tall front support 140 includes a first tall front support 140A extending from a top portion of the first side 212 of the ladder 210, and a second tall front support 140B extending from a top portion of the second side 214 of the ladder 210. The first tall front support 140A comprises an extension mechanism, for example, similar to the side leg 104 and the side extender leg 108. The first tall back support 140A is affixed to the ladder 210 at its first end by a front support joint 142A, and at its second end opposite the first end, includes a front support shoe 144A to rest on, and enhance grip with the ground, or a resting surface. The second tall front support 140B is a mirror image of the first tall back support 140A.

In some embodiments, a ladder stabilization apparatus may include one or more of side stabilizers (for each side), for example, the side stabilizers 103 of FIGS. 1 and 2; front-back stabilizers (for each side), for example, the front-back stabilizers 111 of FIGS. 1 and 2; a bridge, for example, the bridge 117 of FIGS. 1-3; a tall back support, for example, the tall back support 130 of FIG. 3; or a tall front support, for example, the tall front support 140 of FIG. 3.

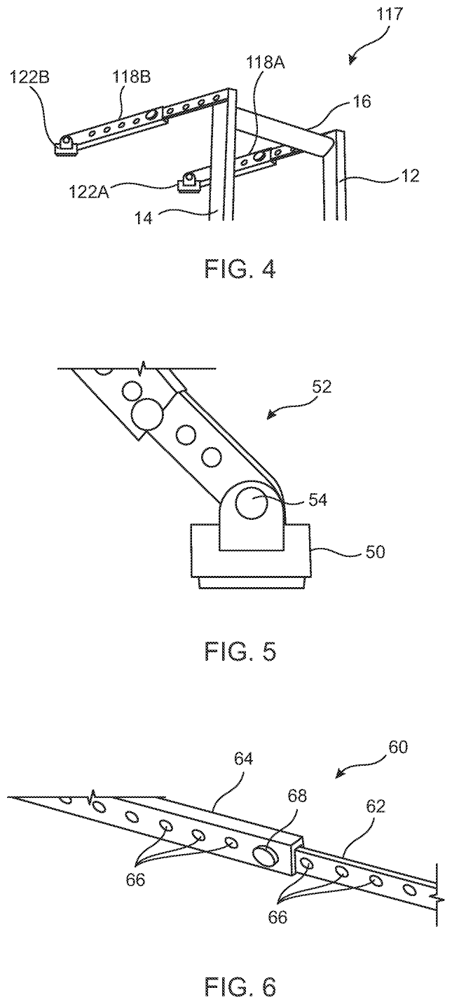

FIG. 4 depicts the bridge 117 of FIGS. 1 and 2 with extendable bridge arms 118A, 118B, and bridge rest shoes 122A, 122B (shown in broken line) resting on the structure. FIG. 5 depicts a shoe 50 positioned at an end of an arm (or leg) 52 with a swivel joint 54. The swivel joint 54 allows the shoe to conform to a profile of a surface on which the shoe rests. FIG. 6 depicts an embodiment of an extension mechanism 60, in which an extension 62 is housed within an arm (or leg) 64 in a telescopic configuration. The arm (or leg) 64 and the extension 62 comprises holes 66, and a removable joint 68. The extension 62 can be extended or contracted by moving the extension within the arm (or leg) 64, overlapping holes at a desired position, and applying the joint 68. The joint 68 is a joint as known in the art, used for relative locking of two members at overlapping holes of both members. Such joints include a spring-loaded bolt which passes through holes 66 in both members, locking relative movement between the two members

In some embodiments, one or more of the joints of the ladder stabilization apparatus, for example, the joints 106, 108 are removable. In some embodiments, one or more of the arm or legs of the ladder stabilization apparatus are extendable, that is, each comprises an extension mechanism. In some embodiments, the arms or legs of the ladder stabilization apparatus include a shoe at an end thereof that rests on a surface, for example, the ground, or the structure, for enhancing the grip thereto and preventing slippage. In some embodiments, the ladder 10 or 210, in use, is configured to rest against the structure 20 with a slight tilt towards the structure 20, for example, up to 15 degrees from the vertical.

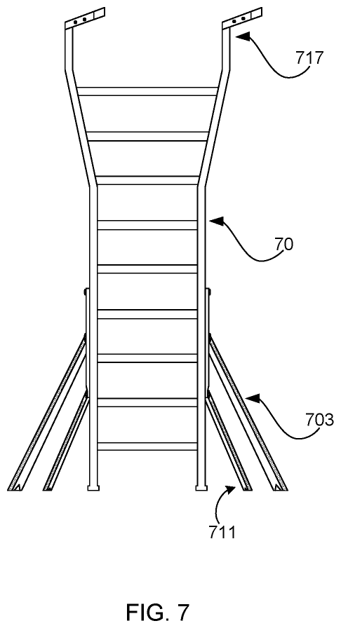

Several features of the ladder stabilization apparatus are symmetrical, that is, the structure on the first side (12 or 212) is identical to the structure on the second side (14 or 214), except that the structures are a mirror image of one another. As an example, the side leg 113A extending from the first side 12 of FIG. 2 is the mirror image of the side leg 113B extending from the second side 14. Unless otherwise mentioned, the reference numerals have suffices “A” and “B” to differentiate between the components on different sides, although collectively, such components are referred to without the use of the suffixes. While a limited number of extension mechanisms are discussed herein, all extension mechanisms for configuring extensibility of arms/legs of the ladder stabilization apparatus, as known in the art, are contemplated herein. In some embodiments, the top of the ladder is broad enough, such that the bridge arms are apart to allow the user to pass between the bridge arms comfortably. In some embodiments, the bridge arms have a length to allow for sufficient gap between the ladder and the structure to allow the user to pass through. FIG. 7 depicts a ladder 70 having a ladder stabilization apparatus 700, according to an embodiment of the invention. The ladder stabilization apparatus comprises side stabilizers 703, front-back stabilizers 711 and bridge 717. As seen in FIG. 7, the ladder 70 widens towards the top so that the bridge 717 is wide to allow a user to pass therethrough comfortably. As also seen, the bridge 717 arms are long, to provide more depth to the bridge 717, to allow a user to pass therethrough comfortably.

While the foregoing is directed to embodiments of the present invention, other and further embodiments of the invention may be devised without departing from the basic scope thereof. The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

It should be understood that various alterations, adjustments, changes and modifications to the presently preferred embodiments described herein will be apparent to those skilled in the art. Such changes and modifications may be made without departing from the spirit and scope of the present invention and without diminishing its attendant advantages. It is, therefore, intended that such alterations, adjustments, changes and modifications be covered by claims appended hereto.

1. A ladder stabilization apparatus comprising:
a first support bracket having a top end and a bottom end, the first support bracket attachable on a first side of a ladder;
a first side stabilizer comprising:
a side leg extending sideway and downward from the first support bracket, the side leg comprising a top end and a bottom end opposite the top end,
a side leg joint configured to attach the top end of the side leg proximal to the top end of the first support bracket, and the top end of the first support bracket to the first side of the ladder,
a side extender leg comprising a top end and a bottom end opposite the top end, the side extender leg configured to extend adjustably from the bottom end of the side leg on a top end of the side extender leg, and rest on the ground on a second side of the side extender leg, the second side opposite the first side, and
a side extender leg joint between the side leg and the side extender leg, the side extender leg joint configured to adjustably lock the side extender leg relative to the side leg proximal to the bottom end of the side leg; and
a first front-back stabilizer comprising:
a front-back leg pair comprising a front leg and a back leg, each leg having a top end and bottom end,
a front-back leg pair joint configured to attach the top ends of the front leg and the back leg to the first support bracket proximal to the bottom end of the first support bracket, and the bottom end of the first support bracket to the first side of the ladder,
wherein the front leg and the back leg extend from the front-back leg pair joint downward and towards the front and the back, respectively, the bottom ends of the front leg and the back leg configured to rest on the ground on opposite sides of the first support bracket.

2. The apparatus of claim 1, further comprising:
a second support bracket attachable on second side of the ladder, the second side opposite the first side, the second support bracket a mirror image of the first support bracket;
a second side stabilizer extending from a region proximal to a top end of the second support bracket, the second side stabilizer a mirror image of the first side stabilizer; and
a second front-back stabilizer extending from a region proximal to a bottom end of the second support bracket, the second front-back stabilizer a mirror image of the first front-back stabilizer.

3. The apparatus of claim 2, further comprising:
a first tall back support comprising a top end and a bottom end opposite the top end, extending backward and downward from the first side of the ladder, wherein the first tall back support is extendable;
a first tall back support joint configured to attach the top end of the first tall back support to a middle portion of the first side of the ladder;
a second tall back support extending backward and downward from the second side of the ladder; and
a second tall back support joint configured to attach the top end of the second tall back support to a middle portion of the second side of the ladder,
wherein each of the second tall back support and the second tall back support joint is a mirror image of the first tall back support and the first tall back support joint.

4. The apparatus of claim 3, further comprising:
a first tall front support comprising a top end and a bottom end opposite the top end, extending frontward and downward from the first side of the ladder, wherein the first tall front support is extendable;
a first tall front support joint configured to attach the top end of the first tall front support to a top portion of the first side of the ladder;
a second tall front support extending frontward and downward from the second side of the ladder; and
a second tall front support joint configured to attach the top end of the second tall front support to a top portion of the second side of the ladder,
wherein each of the second tall front support and the second tall front support joint is a mirror image of the first tall front support and the first tall front support joint.

5. The apparatus of claim 2, further comprising:
a bridge attachable to a top of the ladder, the bridge comprising:
a pair of bridge arms extending outward from the first side and the second side of the ladder, at a respective proximal end of the pair of bridge arms, and respective distal ends of the bridge arms configured to rest on a structure, the distal ends opposite the proximal ends, and
a pair of bridge joints, each configured to attach each of the pair of bridge arms to the top of the ladder, at a respective side of the ladder.

6. The apparatus of claim 5, wherein each of the pair of bridge arms are extendable in length.

7. The apparatus of claim 6, wherein each of the pair of bridge arms comprise a shoe on the respective distal ends.

8. The apparatus of claim 2, further comprising:
a first tall back support comprising a top end and a bottom end opposite the top end, extending backward and downward from the first side of the ladder, wherein the first tall back support comprises an extension mechanism;
a first tall back support joint configured to attach the top end of the first tall back support to a middle portion of the first side of the ladder;
a second tall back support extending backward and downward from the second side of the ladder; and
a second tall back support joint configured to attach the top end of the second tall back support to a middle portion of the second side of the ladder,
wherein each of the second tall back support and the second tall back support joint is a mirror image of the first tall back support and the first tall back support joint.

9. The apparatus of claim 8, further comprising:
a first tall front support comprising a top end and a bottom end opposite the top end, extending frontward and downward from the first side of the ladder, wherein the first tall front support comprises an extension mechanism;
a first tall front support joint configured to attach the top end of the first tall front support to a top portion of the first side of the ladder;
a second tall front support extending frontward and downward from the second side of the ladder; and
a second tall front support joint configured to attach the top end of the second tall front support to a top portion of the second side of the ladder,
wherein each of the second tall front support and the second tall front support joint is a mirror image of the first tall front support and the first tall front support joint.

10. A ladder comprising:
a first side;
a second side, the second side opposite the first side;
a plurality of steps extending horizontally from the first side to the second side;
a ladder stabilization apparatus comprising:
a first support bracket having a top end and a bottom end, the first support bracket attachable on the first side of a ladder,
a first side stabilizer comprising:
a side leg extending sideway and downward from the first support bracket, the side leg comprising a top end and a bottom end opposite the top end,
a side leg joint configured to attach the top end of the side leg proximal to the top end of the first support bracket, and the top end of the first support bracket to the first side of the ladder,
a side extender leg comprising a top end and a bottom end opposite the top end, the side extender leg configured to extend adjustably from the bottom end of the side leg on a top end of the side extender leg, and rest on the ground on a second side of the side extender leg, the second side opposite the first side, and
a side extender leg joint between the side leg and the side extender leg, the side extender leg joint configured to adjustably lock the side extender leg relative to the side leg proximal to the bottom end of the side leg, and
a first front-back stabilizer comprising:
a front-back leg pair comprising a front leg and a back leg, each leg having a top end and bottom end,
a front-back leg pair joint configured to attach the top ends of the front leg and the back leg to the first support bracket proximal to the bottom end of the first support bracket, and the bottom end of the first support bracket to the first side of the ladder,
wherein the front leg and the back leg extend from the front-back leg pair joint downward and towards the front and the back, respectively, the bottom ends of the front leg and the back leg configured to rest on the ground on opposite sides of the first support bracket.

11. The ladder of claim 10, further comprising:
a second support bracket attachable on second side of the ladder, the second side opposite the first side, the second support bracket a mirror image of the first support bracket;
a second side stabilizer extending from a region proximal to a top end of the second support bracket, the second side stabilizer a mirror image of the first side stabilizer; and
a second front-back stabilizer extending from a region proximal to a bottom end of the second support bracket, the second front-back stabilizer a mirror image of the first front-back stabilizer.

12. The ladder of claim 11, further comprising:
a first tall back support comprising a top end and a bottom end opposite the top end, extending backward and downward from the first side of the ladder, wherein the first tall back support is extendable;
a first tall back support joint configured to attach the top end of the first tall back support to a middle portion of the first side of the ladder;
a second tall back support extending backward and downward from the second side of the ladder; and
a second tall back support joint configured to attach the top end of the second tall back support to a middle portion of the second side of the ladder,
wherein each of the second tall back support and the second tall back support joint is a mirror image of the first tall back support and the first tall back support joint.

13. The ladder of claim 12, further comprising:
a first tall front support comprising a top end and a bottom end opposite the top end, extending frontward and downward from the first side of the ladder, wherein the first tall front support is extendable;
a first tall front support joint configured to attach the top end of the first tall front support to a top portion of the first side of the ladder;
a second tall front support extending frontward and downward from the second side of the ladder; and
a second tall front support joint configured to attach the top end of the second tall front support to a top portion of the second side of the ladder,
wherein each of the second tall front support and the second tall front support joint is a mirror image of the first tall front support and the first tall front support joint.

14. The ladder of claim 11, further comprising:
a bridge attachable to a top of the ladder, the bridge comprising:
a pair of bridge arms extending outward from the first side and the second side of the ladder, at a respective proximal end of the pair of bridge arms, and respective distal ends of the bridge arms configured to rest on a structure, the distal ends opposite the proximal ends, and
a pair of bridge joints, each configured to attach each of the pair of bridge arms to the top of the ladder, at a respective side of the ladder.

15. The ladder of claim 14, wherein each of the pair of bridge arms are extendable in length.

16. The ladder of claim 15, wherein each of the pair of bridge arms comprise a shoe on the respective distal ends.

17. The ladder of claim 11, further comprising:
a first tall back support comprising a top end and a bottom end opposite the top end, extending backward and downward from the first side of the ladder, wherein the first tall back support is extendable;
a first tall back support joint configured to attach the top end of the first tall back support to a middle portion of the first side of the ladder;
a second tall back support extending backward and downward from the second side of the ladder; and
a second tall back support joint configured to attach the top end of the second tall back support to a middle portion of the second side of the ladder,
wherein each of the second tall back support and the second tall back support joint is a mirror image of the first tall back support and the first tall back support joint.

18. The ladder of claim 17, further comprising:
a first tall front support comprising a top end and a bottom end opposite the top end, extending frontward and downward from the first side of the ladder, wherein the first tall front support is extendable;
a first tall front support joint configured to attach the top end of the first tall front support to a top portion of the first side of the ladder;
a second tall front support extending frontward and downward from the second side of the ladder; and
a second tall front support joint configured to attach the top end of the second tall front support to a top portion of the second side of the ladder,
wherein each of the second tall front support and the second tall front support joint is a mirror image of the first tall front support and the first tall front support joint.

19. The ladder of claim 10, wherein the first side and the second side, each comprises:
a respective extender configured to extend therefrom; and
a shoe at an end of the extender opposite the respective first side or the second side.
